(19) United States
(12) Patent Application Publication
(10) Pub. No.: US 2026/0048976 A1
(43) Pub. Date: Feb. 19, 2026

(54) BEVERAGE COOLING SYSTEM

(71) Applicant: Aquablu Holding B.V., Amsterdam (NL)

(72) Inventors: Max Daniel Boo HOEBOER, Amsterdam (NL); Morné Douw VAN HEERDEN, Amsterdam (NL); Marnix Jacob Paul STOKVIS, Amsterdam (NL); Marc Leopold Robert VAN ZUIJLEN VAN NIJEVELT, Amsterdam (NL)

(21) Appl. No.: 19/298,677

(22) Filed: Aug. 13, 2025

(30) Foreign Application Priority Data
Aug. 14, 2024 (NL) 2038438

(51) Int. Cl. B67D 1/08

(52) U.S. Cl. CPC B67D 1/0857

(57) ABSTRACT

The present invention relates to a beverage cooling system comprising: a beverage inlet; a beverage (conduit system comprising at least one beverage supply conduit; a primary cooling buffer unit positioned in fluid connection with the beverage supply conduit, the primary cooling buffer unit optionally comprising a thermally insulated compartment comprising a fluid/solid reservoir in thermal contact with the beverage supply conduit; a dry block cooling unit positioned downstream of the primary cooling buffer unit, the dry block cooling unit including a phase change cooling unit and a heat exchange block in fluid connection with the beverage supply conduit, a chilled beverage outlet, and a control system comprising at least one temperature sensor and at least one flow controller, wherein the control system is configured to regulate the operation of the phase change cooling unit and beverage flow based on temperature data from the temperature sensors and flow data.

### CROSS-REFERENCE TO RELATED APPLICATIONS

This application claims the benefit and priority to Netherlands Patent Application No. 2038438, filed on 14 Aug. 2024. The entire disclosure of the application identified in this paragraph is incorporated herein by reference.

### FIELD

The present invention relates to beverage cooling systems, in particular to point of use systems that provide potable water and beverages based on the potable water utilizing a cooling unit to produce the beverages at a set temperature at a point of use.

### BACKGROUND

Beverage cooling systems are widely used in various settings such as restaurants, bars, residential and office environments, to provide beverages at desired temperatures and with desired carbonation.

Conventional beverage cooling systems typically comprise either a dry block cooling unit, or a cooling buffer unit, such as ice bath cooling units, also known as ice bank cooling units or ice banks, which involves a water reservoir and cooling circuits suspended in reservoir. Ice bank coolers operate by forming ice around the cooling circuits within the reservoir to provide cooling for beverages.

Ice bath coolers generally have a high cooling capacity due to enhanced thermal energy transfer, a large heat capacity when sufficiently large volumes of coolant are employed but react slowly to temperature changes due to the nature of ice acting as a heat sink, and are maintenance intensive since the beverage acts as coolant, and hence requires enhanced hygienic treatments to avoid growth of pathogens.

Dry block coolers or chillers on the other hand operate by providing a chilled metal block acting as heat sink to provide effective cooling. Typically, this concerns a larger metal block enveloping the beverage piping and acting as a heat exchanger when coupled to cooling device, such as a compressor-expander cooling unit, or a Pelletier element. Due to the high heat capacity of the metal bock, aliquots of beverages can be effectively cooled by flowing though the unit. Dry block coolers have the benefit of easy maintenance and easy hygiene. However, they can be energy-intensive and are generally better suited for smaller volumes of beverages to be cooled as the size of the metal block increases with increased volumes.

Accordingly, for intensive use of beverage dispensing units providing different beverages at different temperatures and compositions, there is a need for a beverage cooling system that can both provide large volumes of beverages, although in different compositions, and with different temperatures and pressures.

A further object of the present invention is to provide a beverage cooling machine for producing beverages that has greater versatility and enables a greater variety of beverages to be produced.

A further object of the present invention is to provide a cooling system in a dispensing device that enables to enhance the quality of the beverages produced to be increased.

A still further object of the present invention is to provide a beverage coolant and mixing device that enables both cold and sparkling beverages to be produced, with high energy efficiency.

The objects of the present invention are achieved with a device according to the independent claims.

### SUMMARY

The present invention provides a beverage cooling system, i.e. a system for reducing the temperature (also referred herein as cooling) of one or more fluids, such as beverages, to a set exit temperature, for the purpose of improving their taste, preserving their quality, or making them more refreshing for consumption.

The beverage cooling system integrates a dry block cooling unit and one or more cooling buffer units, (a primary and optionally a secondary cooling buffer units) combining the benefits of both cooling technologies which work together to compensate for fluctuations in the dry block cooling unit, while offering a higher heat capacity.

In this manner the beverage cooling system provides an exceptional cooling efficiency and maintains consistent beverage temperatures. The dry block cooling unit ensures rapid initial cooling, while the primary cooling buffer unit maintains the beverage at the desired temperature over extended usage.

In an aspect of the present invention, there is provided a beverage cooling system comprising:
a beverage inlet;
a beverage conduit system comprising at least one beverage supply conduit;
a primary cooling buffer unit positioned in fluid connection with the beverage supply conduit, the primary cooling buffer unit comprising optionally a thermally insulated compartment comprising a fluid/solid reservoir in thermal contact with the beverage supply conduit;
a dry block cooling unit positioned downstream of the primary cooling buffer unit, the dry block cooling unit including a phase change cooling unit and a heat exchange block in fluid connection with the beverage supply conduit,
a chilled beverage outlet, and
a control system comprising at least one temperature sensor and at least one flow controller.

Further, the control system may be configured to indirectly regulate the operation of the dry block cooling unit, or phase change cooling unit, and to control beverage flow based on temperature data from the temperature sensors and flow data, and further the control system may be configured to estimate the flow data based on operating parameters of the flow controller, or optionally the control system comprises at least one flow sensor configured to provide flow data.

In some embodiments, the control system is configured to regulate the operation of the phase change cooling unit and beverage flow based on temperature data from the temperature sensors and flow data.

The control system may comprise a processor. The controls system may comprise at least one temperature sensor that is thermally coupled to the dry block cooling unit, for example to the heat exchange block.

The control system may indirectly regulate the operation of the dry block cooling unit by adjusting pump operation based on temperature readings. In some embodiments, the control system is configured to activate the pump when the temperature of the heat exchange block is below a predetermined maximum temperature.

The flow data may be obtained optionally from a flow sensor or estimated by the control system (e.g. by the processor) based on operating parameters of the flow controller, such as pump speed, valve position, or actuator displacement.

In some embodiments, the control system comprises at least one flow sensor, which is configured to measure the flow rate of the beverage and provide flow data for system regulation. In some embodiments, the control system is configured to estimate the flow data based on operating parameters of the flow controller.

In some embodiments, the control system further includes a user interface for setting the desired beverage temperature. The control system may further comprise one or more actuators, wherein the one or more actuators are pumps.

In some embodiments, the beverage conduit system further comprises at least one recirculation conduit in fluid connection with the dry block cooling unit and the primary cooling buffer unit, wherein the recirculation conduit is configured to recirculate cooled beverage from the dry block cooling unit to the primary cooling buffer unit.

In some embodiments, the fluid/solid reservoir of the primary cooling buffer unit is filled at least partially with a phase change material or a heat transfer fluid.

In some embodiments, the primary cooling buffer unit of the beverage cooling system described above may comprise at least one heat transfer element located within the fluid/solid reservoir.

Further, the heat transfer element has a heat exchange portion that is at least in part submerged in the phase change material or heat transfer fluid in the fluid/solid reservoir.

The beverage supply conduit of the beverage cooling system may be connected to the heat transfer element. In some embodiments, the heat transfer element is a coil, configured to transfer heat between the beverage flowing through it and either the heat transfer fluid or phase change material contained within the fluid/sold reservoir. The coil may comprise a thermally conductive material, preferably metal, more preferably stainless steel, copper or aluminium.

In some embodiments, the fluid/solid reservoir of the primary cooling buffer unit is at least partially filled with a heat transfer fluid, configured to withstand beverage inlet pressure and beverage inlet pressure fluctuations, and wherein the heat transfer fluid, in the fluid/solid reservoir is configured as a heat sink.

In some embodiments, the fluid/solid reservoir of the primary cooling buffer unit is at least partially filled with a mixture of a beverage circulating within beverage cooling system and the heat transfer fluid, wherein the beverage and the heat transfer fluid have different temperatures at the time of mixing.

Further, the heat transfer fluid may comprise a beverage, preferably the beverage circulating within the beverage cooling system. In some embodiments, the heat transfer fluid is water, preferably potable water.

The heat exchange block of a dry block cooling unit may comprise a thermally conductivity material.

In some embodiments, the beverage in the beverage cooling system described above is circulated continuously upon reaching a temperature equilibrium.

The beverage circulating within the beverage cooling system can be selected from the group comprising water, potable water, sparkling water, carbonated beverages, flavoured beverages, juices, teas, soft drinks, sports drinks, energy drinks, or alcoholic beverages.

In some embodiments, the beverage circulating within the beverage cooling system is water, preferably potable water.

Advantageously, the beverage cooling system may further comprise a secondary cooling buffer unit and/or an auxiliary heat exchanger, each in thermal contact with the recirculation conduit.

Preferably, the beverage cooling system described above can be executed as a closed loop cooling system. The beverage cooling system is being configured to cool a beverage from an inlet temperature T1 to a set exit temperature T2, wherein T1>T2.

In the beverage cooling system of the present invention, the dry block cooling unit, the primary cooling buffer unit, optionally the secondary cooling buffer unit may each comprise a thermally insulated housing.

The beverage cooling system may further comprise a carbonator and carbonation circuit with CO₂ inlet, wherein the carbonator is in fluid communication with the dry block cooling unit.

In some embodiments, the beverage cooling system described above may further comprise a purge line connected to the primary cooling buffer unit configured to purge the beverage in the fluid/solid reservoir.

In a further aspect of the present disclosure, the present disclosure provides for a process for the point of use provision of cooled beverages, the process comprising: providing a beverage diluent fluid or beverage to the beverage cooling system according to the disclosure; cooling the beverage or beverage diluent fluid to a set temperature; optionally pressurizing the cooled beverage or beverage carrier fluid to a set temperature with a carbon dioxide; and supplying the cooled beverage or beverage carrier fluid to a beverage dispensing unit.

A further aspect of the present disclosure relates to the use of the beverage cooling system according to the disclosure for the point of use delivery of cooled beverages. The beverage cooling system may further comprise a secondary cooling buffer unit, and/or an auxiliary heat exchanger, to be in thermal contact with the recirculation conduit. The beverage cooling system may further comprise a carbonator and carbonation circuit with CO₂ inlet, wherein the carbonator is in fluid communication with the dry block cooling unit. To ensure optimal carbonation in the carbonator, the temperature of the beverage coming from the dry cooling unit is preferably maintained below 6° C. Also, the beverage cooling system may further comprise a purge line connected to the primary cooling buffer unit configured to purge the beverage (water or potable water) in the fluid/solid reservoir.

### BRIEF DESCRIPTION OF THE DRAWINGS

To easily identify the discussion of any particular element or act, the most significant digit or digits in a reference number refer to the figure number in which that element is first introduced. Some ways of implementing the invention are disclosed below by way of a non-limiting example, with reference to the attached drawings, in which:

FIG. 1 illustrates schematic view of the beverage cooling system comprising a dry block cooling unit, a primary cooling buffer unit, a secondary cooling buffer in accordance with an embodiment.

FIG. 2 presents a schematic view of another type of state-of the art beverage cooling system showing cooling of the water/fluid by using only an ice bank cooler 33.

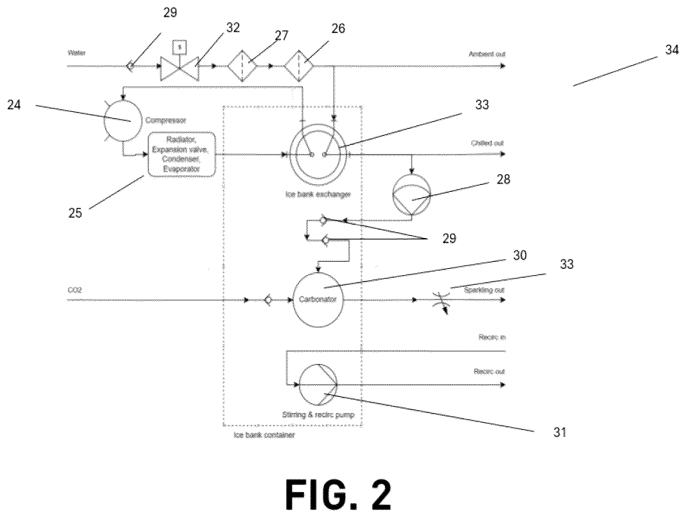

FIG. 3 illustrates an aspect of the beverage cooling system in accordance with one embodiment.

FIG. 4 illustrates an aspect of the beverage cooling system in accordance with one embodiment.

FIG. 5 illustrates an aspect of the beverage cooling system in accordance with an embodiment.

FIG. 6 illustrates a simplified version of the beverage cooling system having an open recirculation loop.

FIG. 7 illustrates a simplified version of the beverage cooling system having a closed recirculation loop.

### DETAILED DESCRIPTION

While the invention has been illustrated and described in detail in the drawings and description, the same is to be considered as illustrative and not restrictive in character, it being understood that only the preferred embodiments have been shown and described and that all changes, equivalents, and modifications that come within the scope or spirit of the inventions defined by following claims are desired to be protected.

It is also contemplated that structures and features embodied in the present examples can be altered, rearranged, substituted, deleted, duplicated, combined and added to each other.

Articles “the”, “a”, and “and” are not necessarily limited to mean only one but rather are inclusive and open-ended so as to include optionally multiple such elements.

The following description provides further information relating to some embodiments of the present disclosure and describes a system and method for providing cooled beverages. It will be appreciated that the features of the disclosure can be combined, as well as being considered separately to that set out above.

A conventional cooling system for cooling liquids such as beverages or water typically includes a refrigeration cycle device, typically having a compressor and expansion chamber. An alternative is a thermoelectric Peltier device. This type of device is often used in low-cost water coolers and is generally arranged to have the cold side of the solid-state Peltier attached to a metal element, which mya be optionally extruded, which projects into a water chamber. When the device is powered electrically, the cold side of the device conducts its thermal gradient to the metal, and then the water gets cooled by convective effects in the water tank. The hot side of the device is typically connected to a suitably proportioned heatsink that dissipates the heat into the surrounding air by a continuous flow of ambient air or a liquid.

The term “beverage diluent”, in the present invention, is intended to mean a liquid, such as potable water, or other liquid that can be either served as beverage or mixed with other ingredients to form a beverage. In general, the beverage diluent liquid is mixed with ingredients to form a beverage. Optionally, the liquid can have CO₂ gas dissolved into the liquid to form a CO₂ infused, or carbonated beverage. Preferably the “beverage diluent” is potable water.

Use of the term “ingredient” refers to a concentrated syrup, percolable powder, flavouring, colouring, preservative, concentrate mixture, non-caloric or caloric sweetener, nutraceuticals, sweetener enhancers, tea, coffee, or combinations thereof, or other types and kinds of substances that can be mixed with a beverage diluent liquid to form a beverage. In general, such ingredients are concentrated forms of ingredients that can be diluted with a beverage diluent liquid to form the beverage.

The term “point of use” herein is intended to mean where the device is intended to be used. Examples of points of use can include, but not be limited to, a consumer home, an office, stores, restaurants, and/or other points of use where the device is intended to be used, and as may be required and/or desired in a particular embodiment.

The term “potable water” refers to drinkable water, water that is safe and suitable for drinking.

The terms “chilled water”, “chilled beverage” and “chilled potable water” refer to water that has been cooled to a temperature that is significantly lower than ambient room temperature but not so cold as to cause discomfort, typically to a range between 2° C. and 15° C., and preferably between 2° C. and 8° C., such that it provides a refreshing sensation but is not so cold as to cause discomfort during consumption.

The term “chilled beverage outlet” refers to an outlet positioned on or connected to a for example the primary cooling buffer unit, through which beverage that has been cooled to a chilled temperature is dispensed.

The term “cool” or “to cool” refers to the process of reducing the temperature of an aliquot of a beverage or potable water.

As used herein, the term “cooling energy” refers to the capacity of a pre-chilled substance or system to absorb thermal energy from its warmer surroundings. According to the present disclosure, a beverage cooling system is provided which is formed by the integration of at least two cooling units, in particular at least one dry block cooling unit and at least one cooling buffer unit. By combining the at least two cooling units, the beverage cooling system may compensate for temperature fluctuations in the dry block cooler, while offering a higher heat capacity due to the increased heat sink provided by the buffer reservoir.

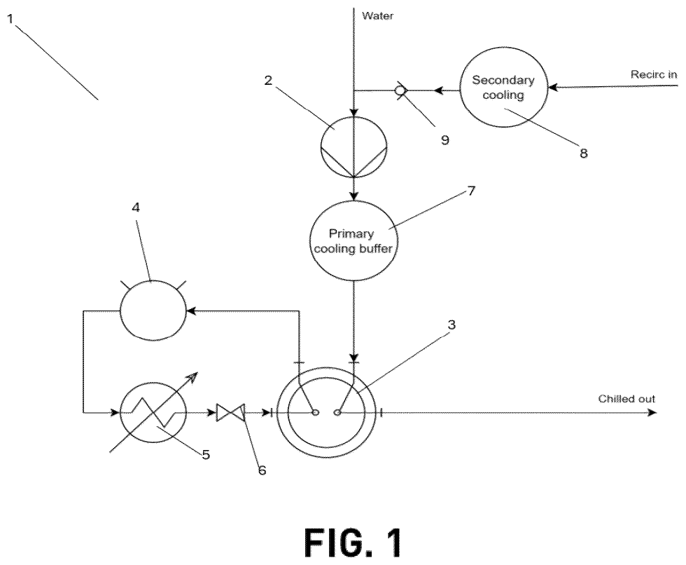

With reference to FIG. 1, the beverage cooling system 1 of the present invention may comprise a primary cooling buffer unit 7, (optionally) a secondary cooling buffer unit 8, a dry block cooling unit 3, a beverage conduit system comprising at least one beverage supply conduit and at least one recirculation conduit, and a pump 2.

Preferably, the beverage cooling system 1 of the present invention is configured to reduce the temperature (cool) of at least one beverage. For example, it can be configured to cool a beverage from an inlet temperature T1 to a set exit temperature T2, wherein T1>T2.

Essentially, the beverage cooling system of the present disclosure is configured to store thermal energy and aims to optimize the balance between maintaining beverage (drink) quality and to operate efficiently during periods of high demand. The combination of dry block cooling unit, one or more cooling buffer unit(s), i.e. a primary and/or secondary cooling buffer unit, and a beverage conduit system minimizes the cooling time while offering a more efficient usage of material and reduced maintenance compared to traditional cooling methods, thereby rendering it an environmentally friendly and cost-effective solution. The beverage cooling system preferably is executed as a closed loop cooling system.

The beverage cooling system of the present disclosure may advantageously be employed in connection with various beverage dispensers and other systems for the purpose of cooling fluids, such as beverages, to a set exit temperature.

Further, the beverage in the beverage cooling system may be selected from water, potable water, carbonated water, also referred to as sparkling water; fruit juice, iced tea, soda, sports drinks, energy drinks, coffee, tea, milk, beer, wine, cocktails, and other mixed beverages. In an embodiment, the beverage is water, preferably potable water. Accordingly, the beverage cooling system may be designed for cooling a variety of beverages, such as water, potable water, still water, sparkling water, specifically cold still water and/or cold sparkling water; carbonated beverages, flavoured beverages, juices, coffee, tea, soft drinks, sports drinks, energy drinks, or alcoholic beverages.

In an exemplary embodiment where the beverage is potable water, the beverage cooling system comprises at least one potable water conduit system, comprising a potable water supply conduit; a primary cooling buffer unit positioned in fluid connection with the potable water supply conduit, the primary cooling buffer unit comprising optionally a thermally insulated compartment comprising a fluid/solid heat reservoir in thermal contact with the potable water supply conduit; a dry block cooling unit positioned downstream of the primary cooling buffer unit, the dry block cooling unit including a phase change cooling unit and a heat exchange block in fluid connection with the water supply conduit, a chilled water outlet connected to the dry block cooling unit, and a control system comprising at least one temperature sensor and at least one flow controller. Further, the control system may be configured to regulate the operation of the phase change cooling unit or the heat exchange block and potable water flow based on temperature data from the temperature sensors and flow data.

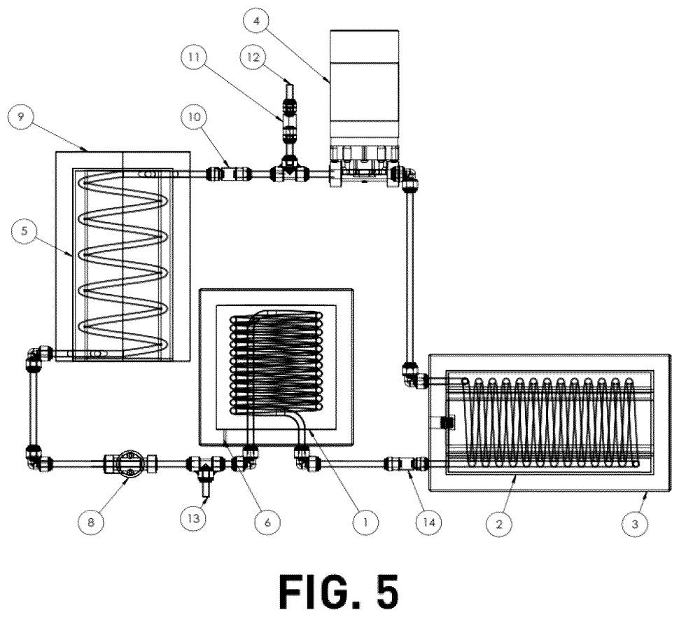

In an embodiment, the beverage cooling system comprises a potable water conduit system comprising a potable water supply conduit and a recirculation conduit, a primary cooling buffer unit 2, a dry block cooling unit 1, a secondary cooling buffer unit 5 to be in thermal contact with the recirculation conduit, and a control system, as shown in FIG. 5.

The beverage cooling system of the present invention may comprise a housing that encases the dry block cooling unit and the primary cooling buffer unit. Preferably, at least one beverage supply conduit as part of the beverage conduit system may also be positioned within the housing and connecting the primary cooling buffer unit and the dry block cooling unit.

The beverage conduit system advantageously comprises a network of conduits designed to supply beverages, such as potable water, interconnecting all elements of the beverage cooling system. It may advantageously comprise a beverage supply conduit, and at least one recirculation conduit preferably forming a closed loop cooling system.

The beverage cooling system can be in communication with a beverage dispenser. For example, the beverage dispenser in communication with the beverage cooling system of can be for still water and/or sparkling water, preferably cold water and/or cold sparkling water.

The beverage conduit system comprises a beverage supply conduit that may be connected to a heat exchange portion that is at least in part submerged in the fluid/solid heat reservoir.

Also, the beverage conduit system may further comprise a recirculation conduit in fluid connection with the dry block cooling unit and the primary cooling buffer unit, wherein the recirculation conduit is configured to recirculate chilled beverage from the dry block cooling unit to the primary cooling buffer unit and then back to the dry block cooling unit.

The dry block cooling unit comprises a phase change cooling unit and a heat exchange block. In the dry block cooler, the heat exchange block is typically a solid piece composed of a high thermally conductivity material, ensuring efficient heat transfer from the beverage to the phase change cooling unit. Examples include, but are not limited to metals, such as aluminium or copper, or metal alloys such as stainless steel, bronze, or the like. Aluminium or aluminium alloys are particularly preferred. The heat exchange block may contain channel or passages through or around which the fluid (beverage) flows.

The heat exchange block itself may be in contact with the beverage, in which case the material of the heat exchange block is chosen to be essentially inert to the beverage or beverage liquid carrier subjected to cooling while passing through the high thermal conductivity material; or there may be embedded conduits in direct contact with the cooling block.

The dry block cooling unit may further comprise at least one temperature sensor.

Where a phase change cooling unit is employed, it may utilize a refrigerant and a refrigeration circuit. The refrigerant typically is a chemical composition that may absorb heat from the heat exchange block and undergo a reversible phase change in its physical state, in particular from liquid to gas or vapour, and vice versa. The refrigeration circuit advantageously is a system that can cool the heat exchange block by transferring heat using the refrigerant. The refrigeration circuit may include one or more of the following components: a compressor, a radiator, a condenser, an expansion valve, and an evaporator; or a thermoelectric Peltier element.

In an embodiment, the heat exchange block of the dry block cooling unit is an aluminium heat exchange block. Aluminium is chosen for its excellent thermal conductivity, allowing for rapid heat absorption from the fluid (beverage) passing through or in contact with the block.

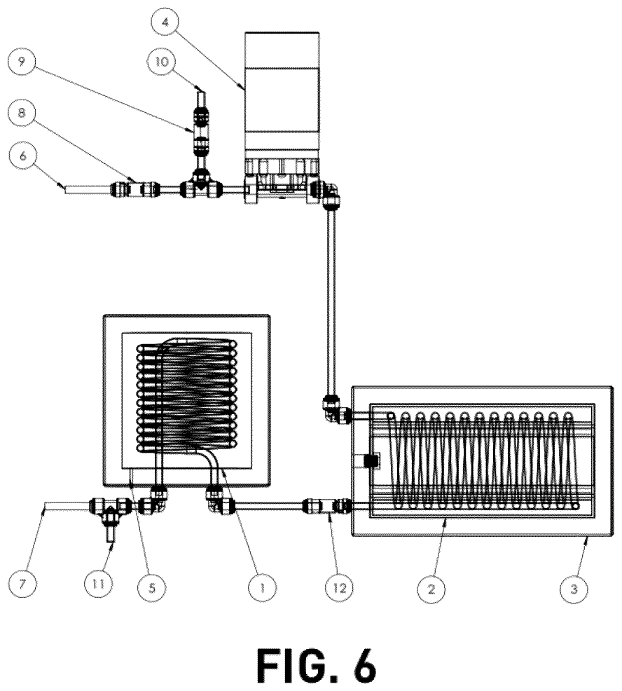

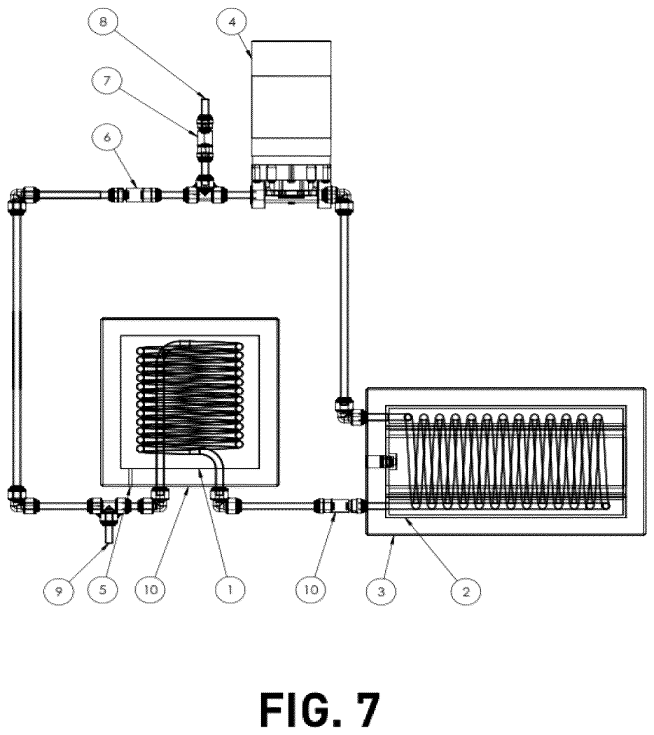

The target temperature range for the heat exchange block can be predetermined based on the optimal serving temperature of the beverage, while remaining safely above the freezing point of water. Accordingly, the dry block cooling unit may preferably comprise a temperature sensor, as for instance shown as item 6 in FIG. 6, and as item 5 in FIG. 7 or 8.

This temperature sensor advantageously monitors the temperature within the dry block cooling unit 1 to ensure it remains within the desired range. Feedback from this sensor may trigger adjustments to the cooling process to maintain efficiency.

Advantageously, the dry block cooling unit may be combined with a phase change cooling unit. The phase change cooling unit may then be responsible for the rapid initial cooling of the beverage, and it supplements the overall cooling process by operating in series with the heat exchange block. Phase change cooling units can generally achieve lower temperatures and handle larger volumes of heat compared to thermoelectric coolers. When including a phase change cooling unit in combination with a dry block cooling unit, the beverage may interact with the phase change cooling unit, where the refrigerant absorbs additional heat from the beverage, ensuring efficient cooling.

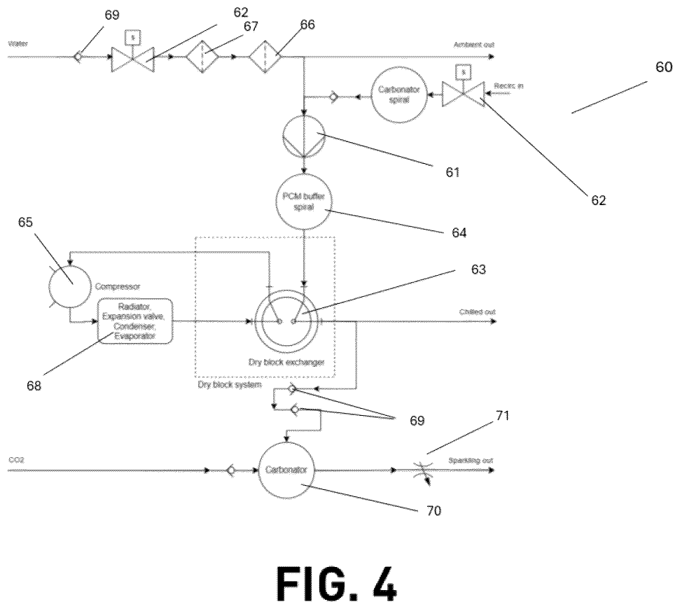

The primary cooling buffer unit 2 may advantageously be located in the proximity of the dry block cooling unit 1, and may advantageously comprise a thermally insulated compartment 3 having a fluid/solid reservoir filled with a cooling fluid or solid, whereby a cooling circuit is advantageously at least partially submerged in the cooling fluid. This ensures that the beverage, e.g. (potable) water being cooled, maintains a consistent low temperature over time, as illustrated in FIGS. 4 to 7.

In an embodiment, the beverage supply conduit is connected to a heat transfer element, wherein the heat transfer element comprises a heat exchange portion that is at least in part submerged in the phase change material or heat transfer fluid in the fluid/solid reservoir. Further, if the beverage is or comprises potable water, the beverage supply conduit is advantageously a potable water supply conduit, which advantageously is at last in part composed of an appropriate food-grade material.

In an embodiment, the primary cooling buffer unit advantageously comprises a thermally insulating housing, a fluid/solid reservoir and a heat transfer element, specifically the fluid/solid reservoir advantageously may comprise the heat transfer element. The heat transfer element can advantageously be a coil, more advantageously wherein the coil may be essentially composed of a metal or metal alloy, such as stainless steel, copper or aluminium.

A coil advantageously comprises a food-grade metal such as stainless steel in contact with the beverage. Although a coil is described herein above as a heat transfer element, the invention is not limited to this shape; other shapes and materials may advantageously be also employed as heat transfer elements. In an embodiment, the fluid/solid reservoir can be a water reservoir, thus comprising water as a heat transfer fluid.

The primary cooling buffer unit may contain a beverage, for example water or potable water, which has been pre-cooled to aid the dry block cooling unit in faster and more efficient cooling of said beverage. The beverage in the primary cooling buffer unit may advantageously be cooled by the heat exchange block of the dry block cooling unit. This aids in maintaining the heat exchange block's temperature by efficiently absorbing heat during peak operation times, i.e. wherein a larger number of beverages are prepared.

Further, the volume of the primary cooling buffer unit is preferably configured to maximize buffered cooling capacity without occupying excessive space within the system.

The primary cooling buffer unit advantageously acts as a heat sink buffer and provides additional cooling capacity by absorbing thermal energy from the warmer beverage. This can be particularly advantageous in cooling systems for a high-volume beverage demand.

The process of preparing beverages in such a system assists in maintaining a consistent output temperature without requiring the dry block cooling unit to run constantly, thus saving energy. The primary cooling buffer unit can stabilize the temperature and ensure a continuous supply.

The primary cooling buffer unit may advantageously be configured as either a direct or indirect cooling buffer unit, implying that there are two methods to store energy in the primary cooling buffer unit.

In an embodiment, the primary cooling buffer advantageously uses a direct heat exchange, and therefore is also referred to as a direct primary cooling buffer unit, wherein the beverage, such as potable water that is distributed to a dispensing unit is also used as the actual heat sink to store energy. In this embodiment, since the cooling energy (i.e., the capacity of the system or substance to absorb thermal energy from its warmer surroundings) is directly stored in the potable water to be dispensed, there is no dependence on heat exchange and flow rates to dispense the water.

Furthermore, such a fluid/solid reservoir of the primary cooling buffer unit is advantageously executed as a food-grade beverage tank, referred to herein as beverage reservoir, which advantageously is designed to withstand the pressure of the cooled beverage supply conduit and used to store beverages, such as (potable) water. This fluid/solid reservoir advantageously has an inlet for the beverage, in particular water or potable water, positioned at a lower position, allowing the incoming beverage to enter from the bottom, helping to push air bubbles upward as the tank fills.

The fluid/solid reservoir furthermore advantageously has a beverage outlet positioned at the upper portion of the reservoir to allow air trapped in the fluid/solid reservoir to escape through the outlet as beverage is drawn off from the top. The beverage outlet is referred to as chilled beverage outlet. The term “chilled beverage outlet” refers to an outlet positioned on the fluid/solid reservoir and configured to dispense beverage that has been cooled by the phase-change cooling unit. As beverage and the heat transfer fluids have different temperatures at the time of mixing, in this configuration, a beverage portion having ambient temperature may advantageously enter the inlet and then mix with the beverage in the reservoir such as water or potable water already present in the primary cooling buffer unit, while the combined volumes flow through the unit.

Advantageously turbulence within the fluid/solid reservoir may be controlled such that the average beverage temperature within the reservoir may be controlled tightly. This may be done actively by e.g. a stirrer, or statically, e.g. by controlling the flow direction of dispensed beverage and the inflow of ambient temperature beverage.

In an embodiment, the fluid/solid reservoir is at least partially filled with a blend of the beverage circulating within beverage cooling system and the heat transfer fluid, wherein the beverage and the heat transfer fluid have different temperatures at the time of blending.

In an embodiment, fluid/solid reservoir is water reservoir configured to contain water, preferably potable water. In an embodiment, the heat transfer fluid of the primary cooling buffer unit is water, where the water is maintained at a non-freezing condition.

In an embodiment, the fluid/solid reservoir of the primary cooling buffer unit is a fluid/solid reservoir configured to store the beverage and to withstand beverage inlet pressure and beverage inlet pressure fluctuations in the beverage supply conduit, wherein the beverage in the fluid/solid heat reservoir serves as a heat sink. Further, a fixed pressure reducer may be employed.

In a further embodiment, the fluid/solid reservoir of the primary cooling buffer unit is a fluid/solid reservoir configured to store potable water, and is configured to withstand water inlet pressure and water inlet pressure fluctuations in the potable water supply conduit, wherein the potable water in the fluid/solid heat reservoir serves as a heat sink.

To address the concern of contamination due to beverage, in particular water or potable water, mixing and prolonged residence times in the fluid/solid reservoir, the beverage cooling system may include a purge line between a CO₂ inlet and the fluid/solid reservoir. This purge line advantageously comprises a solenoid valve, and optionally a check valve. The solenoid valve is normally closed during normal operation. The optional check valve is preferably configured to prevent potable water from entering the CO₂ inlet line in the case that the water pressure is higher than the CO₂ pressure.

In a further embodiment, the primary cooling buffer unit uses a heat transfer element preferably configured as a heat exchanger and therefore is also referred to herein as an indirect primary cooling buffer unit.

The heat transfer element may advantageously be connected to the beverage supply conduit. Advantageously, the heat transfer element or elements may either be suspended within or placed in close thermal contact with the fluid/solid reservoir.

The fluid/solid reservoir may comprise a separate cooling medium. This configuration facilitates efficient thermal exchange between the cooling medium and the heat transfer element, such as through a coil or spiral positioned within the beverage. The cooling medium may include a phase change material and/or a heat transfer fluid. The heat transfer fluid advantageously is water.

The fluid/solid reservoir may further comprise a heat transfer element, preferably in the shape of a coil, preferably a spiral-shaped coil composed of a thermally conductive material, such as metal, preferably, stainless steel, aluminium or copper, more preferably stainless steel. The coil acts as a heat exchanger. The potable water may flow through this coil, facilitating efficient heat exchange within the fluid reservoir. The coil may be at least partially or entirely submerged in either phase change material or a heat transfer fluid, enhancing the efficiency of the heat exchange process within the fluid/solid reservoir.

The fluid/solid reservoir may advantageously comprise with a phase change material (PCM), or other types of materials, which absorbs heat when transferring from the solid to the liquid phase, thereby providing a heat exchange mechanism. For example, a phase change material that melts and solidifies around 3° C. can be used.

In this embodiment, the potable water and the cooling medium are not in direct contact. With the indirect cooling buffer unit type, preferably a sealed container enclosing a food-grade heat exchange unit, such as a cooling spiral (coil) is employed, wherein the container is filled with a cooling medium able to store and release energy. The potable water transported thought the heat exchange unit is preferably fully replaced in the heat exchanger during dispensing, therefore allowing a contamination free cooling.

In operation, the beverage cooling system first activates the dry block cooling unit to rapidly cool the beverage to a desired temperature. In an embodiment, the inlet temperature of the beverage can be in the range between 5° C. and 50° C., or between 15° C. and 25° C., or between 18° C. and 22° C. and the desired and/or set exit temperature to which the beverage is cooled within the dry block cooling unit can be in the range between 1° C. and 10° C.

The degree of (pre)cooling achieved within the beverage cooling system depends on the flow rate of the beverage and the duration of dispensing and pauses between dispenses. In an embodiment, the temperature drop (ΔT) can range from 3° C. during prolonged high flow rates to 16° C. after a 1-3-minute pause, depending on previous usage.

In an embodiment, the beverage cooling system is configured to cool potable water from an inlet temperature T1 to a set exit temperature T2, wherein T1 >T2. Further, T1 can be in the range between 5° C. to 25° C. or between 15° C. and 25° C., or between 18° C. and 22° C., whereas T2 can be the range between 1° C. and 10° C., In an embodiment, a set exit temperature T2 is between 1° C. and 6° C., for example between 2° C. and 6° C., or between 2° C. and 5° C. In an embodiment, the exit temperature T2 is less than to 6° C. In an embodiment, the temperature of the heat exchanger block after precooling can be between 2° C. and 10° C., preferably between 2° C. and 6° C., more preferably between 2° C. and 4° C.

The control system advantageously continuously monitors the temperature, beverage flow, CO₂ pressure and flow and makes adjustments to the cooling process as necessary to ensure consistent beverage temperature.

The control system may comprise one or more pumps and/or one or more valves, dedicated software, a processor configured to run the software, sensors, such as temperature sensors, flow sensors. Different components of a single flow controller may be provided at different positions along a circuit. For instance, a valve may be placed upstream or downstream of a pump comprised by the same flow controller as said valve.

Temperature sensors may be placed on the heat exchange block as required for the thermostat to function properly and optionally within the primary cooling buffer unit for real-time temperature monitoring and system adjustments.

The control system may advantageously comprise at least one temperature sensor and at least one flow controller 8, as shown in FIG. 5.

As used herein, the terms “flow controller” and “flow controller unit” may be used interchangeably to refer to a component or assembly that controls the flow of beverage, optionally including pumping, valving, or flow monitoring functionality. The flow controller 8 is preferably configured to direct the flow of water.

The control system may be configured to regulate indirectly the operation of the dry block cooling unit, such as heat exchange block or the phase change cooling unit and to control the beverage (e.g., water) flow, for example, based on temperature data from the temperature sensors and flow data.

The term “flow data” as used herein refers to information relating to the rate or volume of beverage flow through the system. The flow data may be determined or estimated by the control system in various ways. For example, it may be derived from operating parameters of the flow controller, such as pump speed, or valve position, or by a flow sensor for directly measuring flow.

In some embodiments, the control system may optionally comprise a flow sensor configured to directly determine the flow rate of the beverage and thereby provide flow data. The flow sensor is configured to measure the real-time flow rate of the beverage (e.g., water) in the system. This flow data is transmitted to the control system.

Thus, the flow data may be determined either from a flow sensor or estimated by the control system's processor based on operating parameters of the flow controller, such as pump speed or valve position. The control system uses this flow data, whether estimated or measured, to regulate beverage flow and coordinate operation of the primary cooling buffer unit.

In one example, the beverage cooling system may include a controller (also referred to as central controller) for overall operations and communications. The controller may be any type of programmable processing device, comprising a processor, or similar hardware, for example a recirculation flow controller unit. This controller with a processor, is responsible for executing the described flow control actions. It uses its processor to run the dedicated software, process data received from temperature and flow sensors, perform necessary calculations, and send control signals to components like the flow controller unit 8.

Further, FIG. 5 illustrates a circuit wherein a pump is employed that can either recirculate beverage or build pressure on the outline line required for carbonating water.

In addition, the beverage cooling system may comprise at least one actuator 4, as shown in FIGS. 5 to 7. For example, the actuator can be a pump, such as recirculation pump. The beverage may be pumped through the primary cooling buffer unit 2. For example, a pump 4 may be employed to circulate the beverage from the primary cooling buffer unit 2 through the heat exchange block 1.

This process facilitates a continuous heat exchange between the heat exchange block and the beverage. The heat exchange block may comprise a cooling spiral that is designed to maximize surface area contact with both the heat exchange block and the beverage (e.g. potable water), enhancing the heat exchange process.

The beverage cooling system is preferably governed by software, executed by the control system comprising a processor, that dynamically controls the cooling process, where a priority is given to rapidly bringing the (aluminium) heat exchange block down to the desired temperature range using direct refrigeration techniques, as shown in FIG. 1 and subsequently reducing the temperature of the beverage within the heat exchange block. Once the heat exchange block reaches a target temperature, the software of the control system then activates the pump. This begins the process of moving the beverage (potable water) to cool down the primary cooling buffer unit through the heat exchange element, i.e. the coil (cooling spiral) in the fluid/solid reservoir, or alternatively through mixing with the cooling medium in the fluid/solid reservoir, without increasing the temperature of the heat exchange block. The beverage flows within the recirculation conduit form the direct block cooling unit to the primary cooling buffer unit. The software running on a processor continuously monitors the temperature, adjusting the flow rate of the pump to prevent overheating of the heating exchange block. This ensures that the temperature of the dispensed beverages (drinks) remains consistent and within the desired range at any given time while cooling the primary cooling buffer unit.

In an embodiment, the control system (feedback control system) activates the pump when the temperature of the heat exchange block is below a certain maximum, which in this case can be between 2° C. and 4° C., or in a preferred example can be set at 3.5° C. to recirculate the cooled beverage and to reduce the temperature of the primary cooling buffer unit. Once activated, the control system aims to maintain the heat exchange block's temperature at a set point that is higher than the thermostat's deactivation temperature (that can be for example set at 2.5° C.). Conversely, if the block's temperature exceeds 3.5° C., the control system reduces the power to the pump.

When running the pump at full power does not significantly increase the temperature of the heat exchange block, this indicates that the primary cooling buffer unit is nearly fully cooled or chilled. In such cases, the pump can switch to a mode that reduces power and noise and may even include periodic pauses. When a user starts to dispense a beverage, the pump is immediately turned off to direct all cooling capacity to the beverage being dispensed. After dispensing ends, the pump is turned back on if the heat exchange block's temperature is below the maximum threshold, and this process repeats.

In some embodiments, the control system is configured to activate the pump when the temperature of the heat exchange block is below a predetermined threshold, such that beverage circulated through the heat exchange block of the dry block cooling unit is cooled and returns to the primary cooling buffer unit at a lower temperature, thereby lowering the temperature of the beverage in the primary cooling buffer unit.

Furthermore, the beverage is circulated continuously even after the beverage temperature has reached an equilibrium.

The beverage cooling system may further comprise a carbonator, also called a carbonization device, to infuse the beverage diluent or beverage, preferably water, with carbon dioxide (CO₂) gas under pressure, thereby creating carbonated water.

In an embodiment, the beverage cooling system is in communication with a beverage dispenser configured for dispensing non-carbonated or still water and/or carbonated water. In this case, the beverage dispenser may include a carbonated water valve and a still water valve to control the flow of carbonated water and still water respectively through the beverage dispenser. The carbonated water and the still water may be supplied to a nozzle for use in pouring carbonated water and still water from the beverage dispenser.

FIG. 1 presents a schematic view of the key circuit in the beverage cooling system 1, specifically focusing on the dry block cooling unit and the buffer cooling unit. With reference to FIG. 1, the beverage dispenser comprises a primary cooling buffer unit 7, the dry block cooling unit 3, and a secondary cooling buffer unit 8, pump 2. The primary cooling buffer unit is preferably directly connected to the dry block cooling unit 3.

The dry block cooling unit 3 provides rapid and direct cooling to the beverage, while the primary cooling buffer unit 7 acts as a thermal reservoir and also maintains a pre-cooled or chilled environment, ensuring that the dry block cooling unit can continuously operate at optimal temperatures without the risk of overheating.

Within this primary cooling buffer unit 7, there is a heat transfer element, for example a conduit or coil that is submerged in the buffer water. The primary cooling buffer unit 7 is preferably a water-filled fluid/solid reservoir that holds the cooling spiral or coil submerged in buffer water. This spiral or coil is part of the potable water supply conduit, which allows water to be precooled before it enters the dry block cooling unit 3. The dry block cooling unit 3 is connected to a compressor 4 and to refrigeration system 5 and two-way valve 6. The refrigeration system 5 may include a refrigerator, evaporator, expansion valve and a condenser. The key functionality of the refrigeration system 5 is to absorb heat from the beverage, in particular water, as it passes through the dry block cooling unit 3. The refrigeration system 5 may operate in a continuous cycle, where the refrigerant absorbs heat from the cooling block, is compressed, releases heat in the condenser and then expands and cools before returning to the evaporator coils.

When the dry block cooling unit 3 is chilled to a set temperature, it effectively cools the beverage. This cooled beverage is then pumped to the primary cooling buffer unit where it lowers the temperature of the phase change material or the heat transfer fluid. The phase change material or heat transfer fluid helps maintain a lower temperature in the primary cooling buffer unit. The now warmer beverage is circulated back to the dry block cooling unit, where it is cooled again.

When potable water is being dispensed, the primary cooling buffer unit and optionally the secondary cooling buffer unit are preferably configured to deliver a pre-cooled beverage at a specified temperature (ΔT), which differs from the set exit (outlet) temperature of the dry block cooling unit.

During water dispensing, recirculation of the potable water is stopped to ensure that the energy of the heat exchange block is focused on achieving maximum cooling output for the dispensed beverage, rather than circulating to chill the primary and/or secondary cooling buffer units. The primary cooling buffer unit can then provide additional cooling capacity to the direct block cooling unit by pre-cooling the beverage to a specified temperature. The pre-cooled beverage is preferably circulated to the dry block cooling unit, which requires less energy to further cool the already pre-cooled beverage because the temperature difference between the pre-cooled beverage and the target set exit temperature of the dry block cooling unit is smaller.

A pump circulates the beverage, and entry and exit valves are controlled to minimize the energy required before a beverage tapping or dispensing action. The pump circulating the beverage as well as entry and exit valves may be controlled such as to reduce the amount of energy required prior to a beverage tapping or dispensing action.

The target temperature range for the heat exchange block can advantageously be predetermined based on the optimal serving temperature of the beverage.

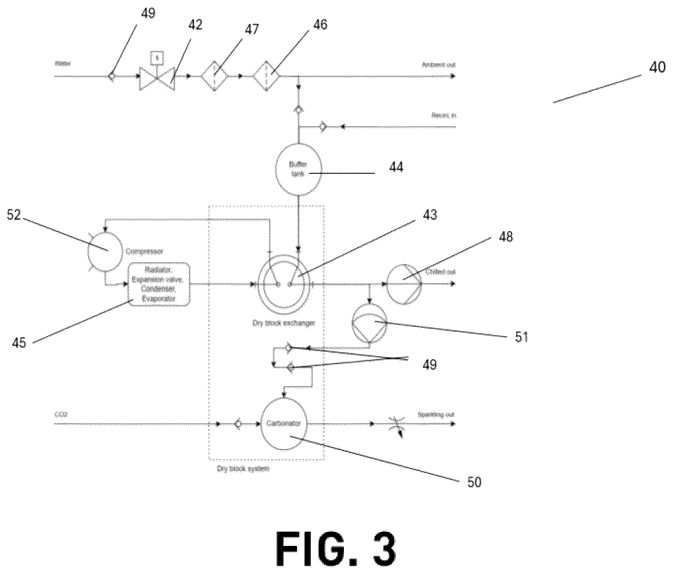

FIG. 3 illustrates an embodiment of the present invention, wherein the beverage cooling system uses a primary cooling buffer unit 44 comprising water as a cooling medium (heat transfer fluid). With reference to FIG. 3, the beverage cooling system 40 comprises a potable water conduit, solenoid valve 42, filter 46 and 47, primary cooling buffer unit 44, a dry block cooling unit 43, compressor 52, refrigeration system 45 comprising radiator, expansion valve condenser and evaporator. The beverage cooling system comprises pump 48, pump 51. The beverage cooling system has a carbonator 50. From the dry block cooling unit 3 the cooled beverage is pumped by a pump 51 into the carbonator 50. The fluid/solid heat reservoir is filled with a potable water acting as a heat sink. Before the dry block cooling unit 43 becomes idle, the pump may be activated to start cooling the primary cooling buffer unit 44.

In some embodiments, a PID (Proportional-Integral-Derivative) control logic may be implemented as part of the software executed by the processor of the same control system that governs overall operation of the beverage cooling system, including temperature regulation and flow control. In particular, the PID algorithm may be executed by the processor within the control system, using input from the temperature sensor (e.g., PT1000) to determine whether recirculation is contributing to heat transfer, and to adjust power usage accordingly.

The PID (Proportional-Integral-Derivative) control system may be used to regulate the temperature.

The PID control system works between the recirculation system and the temperature sensor. The system monitors whether the recirculation process increases the temperature of the dry block cooling unit. If recirculating the water does not increase the dry block's temperature, it indicates that the primary cooling buffer unit is sufficiently chilled. Consequently, the power used for recirculation can be reduced, shifting from active cooling to merely maintaining the current temperature.

FIG. 4 illustrates an embodiment of the present invention, where the beverage cooling system uses a primary cooling buffer unit 64 comprising a coil and a phase change material. The beverage cooling system comprises a single pump 61. Further, the beverage cooling system shown herein uses a primary cooling buffer unit 64 with coil inside the fluid/solid reservoir and phase change material in contact with the coil. The beverage cooling system comprises a potable water inlet, filters 66 and 67, a solenoid valves 62, a pump 61, potable water supply conduits, a primary cooling buffer unit 64, a dry block cooling unit 63, a carbonator 70 and the beverage cooling system 60 includes a carbonated water source and/or a still water source. The dry block cooling unit 63 includes a compressor, refrigerator, a condenser and an evaporator unit. A standard solenoid valve 62 is used for carbonation. In this case a single pump is used together with a standard solenoid valve 62 for switching between carbonation and recirculation of the beverage.

The primary buffer cooling unit 64 comprises a fluid/solid reservoir having a phase change material and a coil or a spiral in contact with the phase change material.

FIG. 5 illustrates a complete hydraulic setup suitable for carbonator pressure building by switching the solenoid valve on the recirculation line. With reference to FIG. 5, the beverage cooling system comprises a dry block cooling unit 1, a primary cooling buffer unit 2, a recirculation pump 4, a secondary cooling buffer unit 5, active cooling unit temperature sensor 6, recirculation flow controller unit 8, recirculation back flow prevention mechanism 10, inlet back flow prevention mechanism 11, potable water supply inlet 12, chilled potable water outlet 13, primary cooling buffer back flow prevention mechanism 14. The potable water enters the beverage cooling system at ambient temperature, for example in the temperature range of from 5° C. to 30° C., or of form 5° C. to 25° C., or of from 10° C. to 22° C.

The dry block cooling unit 1 is the main cooling element within the beverage cooling system. It rapidly cools (reducing the temperature) the potable water to a desired temperature. The primary cooling buffer unit 2 equipped with primary cooling buffer insulation 3, precools the potable water. The primary cooling buffer unit 2 comprises fluid/solid reservoir that is a type of tank filled at least partially or entirely with a cooling medium such as heat transfer fluid (water, or phase change material. The fluid/solid reservoir comprises a heat transfer element in the form of a coil, configured to transfer heat between the potable water flowing through it and either the heat transfer fluid or phase change material contained within the fluid/solid reservoir. The coil or spiral can be constructed from thermally conductive material, such as metal, preferably aluminium or copper.

Further, a recirculation conduit connects the dry block cooling unit 3 with the primary cooling buffer unit 2 for recirculating chilled water from the dry block cooing unit to the primary cooling buffer unit 2. The secondary cooling buffer unit 5, equipped with secondary cooling buffer insulation 9, is integrated into the recirculation circuit, is another cooling unit providing a consistent temperature as the chilled water recirculates back to the primary cooling buffer unit. It acts as a heat sink buffer that can further cool the primary cooling buffer unit during recirculation, reding recovery time in peak moments of usage, the secondary cooling buffer unit 5 is an optional component within the recirculation circuit, which operates as a closed loop, that helps in conserving potable water and energy.

The secondary cooling buffer unit may comprise a phase change material (PCM) or a heat transfer fluid (a cooling medium). The heat transfer fluid is a beverage fluid or beverage, preferably the beverage circulating within the beverage cooling system. The heat transfer fluid can be preferably water. The secondary cooling buffer unit may keep other components of the beverage cooling system of the present invention cooled, such as the carbonator.

FIG. 6 illustrates a beverage cooling system with a recirculation loop. With reference to FIG. 6, the beverage cooling system comprises a potable water supply inlet 10, dry block cooling unit 1, a primary cooling buffer unit 2 with a primary cooling buffer insulation 3, a recirculation pump 4, an active cooling unit temperature sensor 5, a recirculation loop flow in 6, a recirculation loop flow out 7, a recirculation back flow prevention mechanism 8, an inlet back flow prevention mechanism 9, a chilled potable water outlet 11, a primary cooling buffer back flow prevention mechanism.

FIG. 7 illustrates a beverage cooling system with a closed recirculation loop. With refence to FIG. 7, the beverage cooling system comprises a potable water supply inlet 8, a dry block cooling unit 1 active dry block insulation 10, a primary cooling buffer unit 2 with a primary cooling buffer insulation 3, a recirculation conduit in fluid connection with the dry block cooling unit 1 and the primary cooling buffer unit 2, a recirculation pump 4, an active cooling unit temperature sensor 5, recirculation back flow prevention mechanism 6, an inlet back flow prevention mechanism 7, chilled potable water outlet 9. From the inlet, the beverage moves to the primary cooling buffer unit 2 and then to the dry block cooling unit 1. The dry block cooling unit 1 provides an active cooling to the beverage. The cooled beverage is pumped to the primary cooling buffer unit 2 where it exchanges thermal energy with the cooling medium in the primary cooling buffer unit acting as a heat sink. The beverage in the heat transfer element increases its temperature and moves to the dry cooling buffer unit where it is cooled again to a set temperature.

Storing energy in the beverage cooling system allows the dry block cooling unit to perform efficiently during intensive usage. The energy stored can be defined as all energy that would otherwise have to be delivered on the spot by the compressor to cool the beverage from inlet beverage temperature to the set exit temperature.

The beverage cooling system can store energy in both the metal of the heat exchange block, where for example the metal is aluminium, and the water the fluid/solid reservoir.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

What is claimed is:

1. A beverage cooling system comprising:
a beverage inlet;
a beverage conduit system comprising at least one beverage supply conduit;
a primary cooling buffer unit positioned in fluid connection with the beverage supply conduit, the primary cooling buffer unit optionally comprising a thermally insulated compartment comprising a fluid/solid reservoir in thermal contact with the beverage supply conduit;
a dry block cooling unit positioned downstream of the primary cooling buffer unit, the dry block cooling unit including a phase change cooling unit and a heat exchange block in fluid connection with the beverage supply conduit,
a chilled beverage outlet, and
a control system comprising at least one temperature sensor and at least one flow controller.

2. The beverage cooling system according to claim 1, wherein the control system is configured to control beverage flow based on temperature data from the temperature sensor and flow data, and wherein the control system is configured to estimate the flow data based on operating parameters of the flow controller, or optionally the control system comprises at least one flow sensor configured to provide flow data.

3. The beverage cooling system according to claim 1, wherein the beverage conduit system further comprises at least one recirculation conduit in fluid connection with the dry block cooling unit and the primary cooling buffer unit, wherein the recirculation conduit is configured to recirculate cooled beverage from the dry block cooling unit to the primary cooling buffer unit.

4. The beverage cooling system according to claim 1, further comprising a secondary cooling buffer unit and/or an auxiliary heat exchanger, each in thermal contact with the recirculation conduit.

5. The beverage cooling system according to claim 1, wherein the fluid/solid reservoir is filled at least partially with a phase change material or a heat transfer fluid.

6. The beverage cooling system according to claim 1, wherein the primary cooling buffer unit comprises at least one heat transfer element located within the fluid/solid reservoir, and, wherein the heat transfer element has a heat exchange portion that is at least in part submerged in the phase change material or heat transfer fluid in the fluid/solid reservoir.

7. The beverage cooling system according to claim 1, wherein the beverage supply conduit is connected to a heat transfer element.

8. The beverage cooling system according to claim 6, wherein the heat transfer element is a coil, configured to transfer heat between the beverage flowing through it and either the heat transfer fluid or phase change material contained within the fluid/sold reservoir; and
wherein the coil comprises a thermally conductive material, preferably metal, more preferably stainless steel, copper or aluminium.

9. The beverage cooling system according to claim 1, wherein the fluid/solid reservoir is at least partially filled with a heat transfer fluid, configured to withstand beverage inlet pressure and beverage inlet pressure fluctuations, and wherein the heat transfer fluid, in the fluid/solid reservoir is configured as a heat sink.

10. The beverage cooling system according to claim 1, wherein the fluid/solid reservoir is at least partially filled with a mixture of a beverage circulating within beverage cooling system and the heat transfer fluid, wherein the beverage and the heat transfer fluid have different temperatures at the time of mixing.

11. The beverage cooling system according to claim 4, wherein the heat transfer fluid is a beverage, preferably the beverage circulating within the beverage cooling system

12. The beverage cooling system according to claim 11, wherein the heat transfer fluid is water, preferably potable water.

13. The beverage cooling system according to claim 1, wherein the control system further comprises one or more actuators, wherein the one or more actuators are pumps.

14. The beverage cooling system according to claim 1, wherein a beverage is circulated continuously upon reaching a temperature equilibrium.

15. The beverage cooling system according to claim 1, wherein the beverage circulating within the beverage cooling system is selected from the group comprising water, potable water, sparkling water, carbonated beverages, flavoured beverages, juices, teas, soft drinks, sports drinks, energy drinks, or alcoholic beverages.

16. The beverage cooling system according to claim 1, wherein the beverage circulating within the beverage cooling system is water or potable water.

17. The beverage cooling system according to claim 1, wherein the dry block cooling unit, the primary cooling buffer unit, optionally the secondary cooling buffer unit comprise a thermally insulated housing.

18. The beverage cooling system according to claim 1, further comprising a carbonator and carbonation circuit with CO₂ inlet, wherein the carbonator is in fluid communication with the dry block cooling unit.

19. The beverage cooling system according to claim 1, further comprising a purge line connected to the primary cooling buffer unit configured to purge the beverage in the fluid/solid reservoir.

20. A process for the point of use provision of cooled beverages, the process comprising:
providing a beverage diluent fluid or beverage to the beverage cooling system according to claim 1,
cooling the beverage or beverage diluent fluid to a set temperature;
optionally pressurizing the cooled beverage or beverage carrier fluid to a set temperature with a carbon dioxide; and
supplying the cooled beverage or beverage carrier fluid to a beverage dispensing unit.
